(19) United States
(12) Patent Application Publication
(10) Pub. No.: US 2026/0126380 A1
(43) Pub. Date: May 7, 2026

(54) SILICATE CONCENTRATION MONITORING DEVICE AND SILICATE CONCENTRATION MONITORING METHOD

(71) Applicant: SAMSUNG ELECTRONICS CO., LTD., Suwon-si (KR)

(72) Inventors: Jinhyeok Jang, Suwon-si (KR); Changha Lee, Seoul (KR); Yunho Kim, Suwon-si (KR); Alim Jang, Seoul (KR); Minhyun Park, Seoul (KR); Younghun Kim, Suwon-si (KR); Junyoung Oh, Suwon-si (KR); Samjong Choi, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/268,159

(22) Filed: Jul. 14, 2025

(30) Foreign Application Priority Data
Nov. 7, 2024 (KR) 10-2024-0157164
Dec. 31, 2024 (KR) 10-2024-0202662

(51) Int. Cl. G01N 21/3577; B01D 61/42; G01N 21/359

(52) U.S. Cl. CPC G01N 21/3577; B01D 61/428; G01N 21/359; B01D 2313/345

(57) ABSTRACT

A device for monitoring a concentration of silicate in a fluid including the silicate includes a concentrator, a solution reactor configured to introduce a molybdic compound and a reducer to the fluid, and a concentration analyzer configured to output a quantified silicate concentration by measuring an absorbance, wherein the concentrator includes a first electrode, a second electrode spaced apart from the first electrode, a current collector configured to supply power to the first electrode and the second electrode at one side of each of the first electrode and the second electrode, a concentrator flow path which is disposed between the first electrode and the second electrode and is a passage through which the fluid moves, and a cation exchange membrane disposed between the first electrode and the concentrator flow path. A silicate concentration monitoring method is also provided.

### CROSS-REFERENCE TO RELATED APPLICATIONS

This application is based on and claims priority under 35 U.S.C. § 119 to Korean Patent Application Nos. 10-2024-0157164, filed on Nov. 7, 2024, and 10-2024-0202662, filed on Dec. 31, 2024, in the Korean Intellectual Property Office, the disclosures of which are incorporated by reference herein in their entireties.

### BACKGROUND

The present disclosure relates to a silicate concentration monitoring device and a silicate concentration monitoring method.

Along with the advancement and miniaturization of the semiconductor technology, fine impurities included in a material used in a semiconductor manufacturing process have affected product quality. Because a product may be defective due to a fine impurity, impurities need to be minimized in a chemical to be supplied in a semiconductor manufacturing process.

In particular, recently, silicate-based particles may remain in a chemical operation.

Many problems occur because silicate remaining in a chemical still remains without being removed by a filter and is developed in a semiconductor manufacturing process.

At present, a semiconductor chemical material is refined by a material company by using a filter up to a material manufacturing operation, but a filter technique being used is in a state in which a filtering degree faces a technical limit. Particularly, a filter having a pore size of 1 nm to 2 nm is used, but defects due to ultrafine silicate-based particles have still occurred.

Therefore, development of a technique of monitoring whether silicate remains in a semiconductor chemical material is necessary.

### SUMMARY

The present disclosure is directed to monitoring whether silicate remains in a semiconductor chemical material, and provides a silicate concentration monitoring device and a silicate concentration monitoring method capable of monitoring the concentration of silicate even when the silicate remains at a relatively dilute concentration.

The problems to be solved by the present disclosure are not limited to the problems mentioned above, and other problems could be clearly understood by those of ordinary skill in the art from the description below.

According to an aspect of the present disclosure, there is provided a device for monitoring a concentration of silicate in a fluid including the silicate, the device including a concentrator, a solution reactor configured to introduce a molybdic compound and a reducer to the fluid transferred from the concentrator, and a concentration analyzer configured to output a quantified silicate concentration by measuring, at a wavelength of 810 nm, an absorbance of the fluid transferred from the solution reactor, wherein the concentrator includes a first electrode, a second electrode spaced apart from the first electrode, a current collector configured to supply power to the first electrode and the second electrode at one side of each of the first electrode and the second electrode, a concentrator flow path which is disposed between the first electrode and the second electrode and is a passage through which the fluid moves, and a cation exchange membrane disposed between the first electrode and the concentrator flow path.

According to another aspect of the present disclosure, there is provided a method of monitoring a concentration of silicate in a fluid including the silicate, the method including passing the fluid through a concentrator configured to increase the concentration of the silicate, passing the fluid through a solution reactor configured to introduce a molybdic compound and a reducer, and passing the fluid through a concentration analyzer configured to output a quantified silicate concentration by emitting light and measuring an absorbance of the fluid at a wavelength of 810 nm, wherein the concentrator includes a first electrode including a porous carbon electrode, a second electrode spaced apart from the first electrode and including graphite, a current collector configured to supply power to the first electrode and the second electrode at one side of each of the first electrode and the second electrode, a concentrator flow path which is disposed between the first electrode and the second electrode and is a passage through which the fluid moves, and a cation exchange membrane disposed between the first electrode and the concentrator flow path.

In an embodiment of the method, the fluid includes sulfuric acid.

In another embodiment of the method, the passing of the fluid through the concentrator includes: passing a first fluid of the fluid through the concentrator flow path and supplying power by using the first electrode as a positive electrode and the second electrode as a negative electrode; and passing a second fluid of the fluid through the concentrator flow path and supplying power by using the first electrode as the negative electrode and the second electrode as the positive electrode, and an amount of the second fluid that is introduced is less than an amount of the first fluid that is introduced.

In another embodiment of the method, the concentrator further includes: a flow path extending from the concentrator flow path and connected to the solution reactor; a connection flow path branching from the flow path; and a storage container connected to the flow path through the connection flow path, the supplying of the power by using the first electrode as the positive electrode and the second electrode as the negative electrode includes transferring the fluid to the storage container through the connection flow path, and the supplying of the power by using the first electrode as the negative electrode and the second electrode as the positive electrode includes transferring the fluid to the solution reactor through the flow path.

In another embodiment of the method, in the passing of the fluid through the solution reactor, the solution reactor is further configured to introduce a basic pH control agent, and the reducer includes ascorbic acid (C₆H₈O₆).

In another embodiment of the method, in the passing of the fluid through the solution reactor, the molybdic compound is introduced in an amount of about 0.5% to about 5% of an amount of the fluid introduced to the solution reactor, and the reducer is introduced in an amount of about 0.5% to about 5% of the amount of the fluid introduced to the solution reactor.

According to another aspect of the present disclosure, there is provided a device for monitoring a concentration of silicate in an acidic fluid including the silicate, the device including a concentrator, a solution reactor configured to introduce a molybdic compound, a basic pH control agent, and a reducer to the fluid transferred from the concentrator, and a concentration analyzer configured to output a quantified silicate concentration by measuring, at a wavelength of 810 nm, an absorbance of the fluid transferred from the solution reactor, wherein the concentrator includes a first electrode including a porous carbon electrode, a second electrode spaced apart from the first electrode and including graphite, a current collector configured to supply power to the first electrode and the second electrode at one side of each of the first electrode and the second electrode, a concentrator flow path which is disposed between the first electrode and the second electrode and is a passage through which the fluid moves, and a cation exchange membrane disposed between the first electrode and the concentrator flow path, the molybdic compound is introduced in amount of about 0.5% to about 5% of an amount of the fluid introduced to the solution reactor, the reducer is introduced in an amount of about 0.5% to about 5% of the amount of the fluid introduced to the solution reactor, and the basic pH control agent is introduced in an amount by which a pH concentration of the fluid introduced to the solution reactor is adjusted to be about 5 to about 9.

### BRIEF DESCRIPTION OF DRAWINGS

Embodiments of the present disclosure will be more clearly understood from the following detailed description taken in conjunction with the accompanying drawings in which:

FIG. 1A schematically illustrates a silicate concentration monitoring device according to embodiments;

FIG. 1B is a flowchart illustrating a silicate concentration monitoring method according to embodiments;

FIG. 2 illustrates a concentrator according to embodiments;

FIG. 3 is a flowchart illustrating a method of increasing the silicate concentration in a concentrator, according to embodiments;

FIGS. 4A, 4B, 5, and 6 illustrate a method of increasing the silicate concentration in a concentrator, according to embodiments;

FIG. 7 schematically illustrates a concentration analyzer according to embodiments;

FIG. 8A is an ultraviolet (UV) absorbance graph according to a silicate concentration and a wavelength from a silicate concentration monitoring device according to embodiments; and

FIG. 8B is a UV absorbance graph at a wavelength of 810 nm according to a silicate concentration from a silicate concentration monitoring device according to embodiments.

### DETAILED DESCRIPTION OF EMBODIMENTS

Hereinafter, embodiments are described in detail with reference to the accompanying drawings. Like reference numerals in the drawings denote like elements, and thus their repetitive description will be omitted.

In addition, the size or thickness of each component shown in the drawings is shown for convenience of description, and thus, the present disclosure is not necessarily limited to the drawings. In the drawings, thicknesses are enlarged to clearly represent layers and regions. In addition, in the drawings, the thicknesses of some layers and regions are exaggerated for convenience of description.

Throughout the specification, when it is described that a certain portion is “connected” to another portion, this includes not only a case of being “directly connected” but also a case of being “indirectly connected” with another member therebetween. In addition, when it is described that a certain portion “includes” a certain component, this indicates that the certain portion does not exclude another component but may further include another component unless there is another particularly opposite description thereto.

In addition, when it is described that a portion, such as a layer, a film, a region, or a plate, is located “on” another portion, this includes not only a case of being “directly on” another portion but also a case of having another portion in the middle. However, when it is described that a certain portion is located “directly on” another portion, this indicates that no other portion is in the middle. In addition, when a certain portion is “on” a reference portion, this indicates that the certain portion is “on” or “beneath” the reference portion, and does not indicate that the certain portion is necessarily “on” the reference portion in the opposite direction to gravity.

In addition, throughout the specification, “in a top view” indicates that a target portion is viewed from the top, and “in a cross-sectional view” indicates that a cross-section obtained by vertically cutting a target portion is viewed from the front.

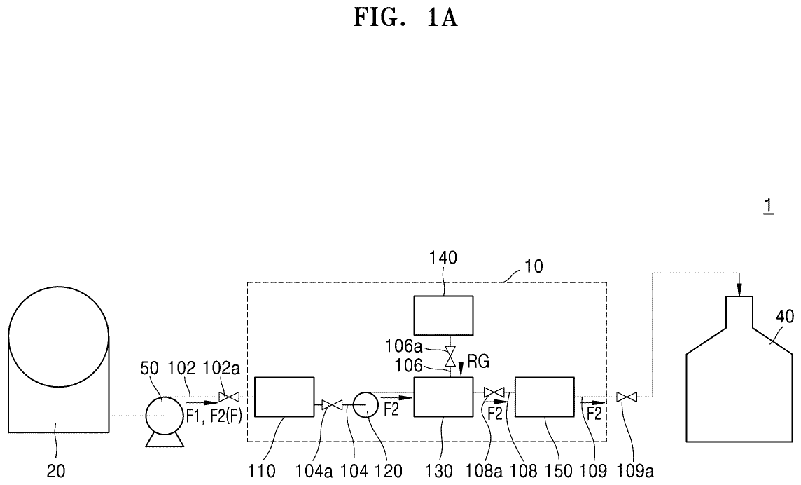

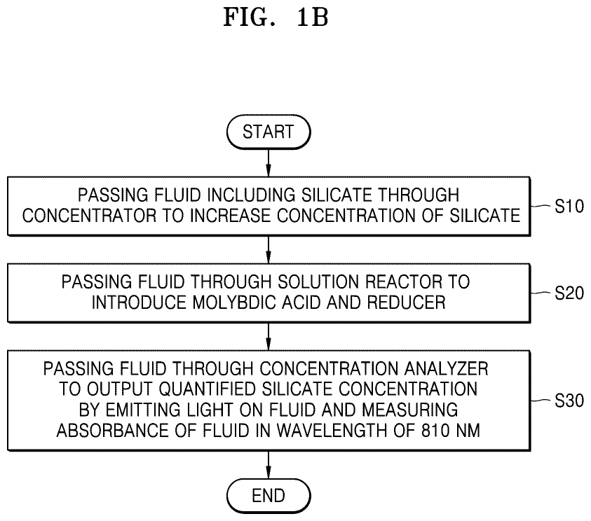

FIG. 1A schematically illustrates a silicate concentration monitoring device 1 according to embodiments.

FIG. 1B is a flowchart illustrating a silicate concentration monitoring method according to embodiments.

Referring to FIGS. 1A and 1B, the silicate concentration monitoring device 1 may include a supply tank 20 for a fluid F in which a silicate concentration is to be measured, a silicate concentration monitoring device 10 configured to receive the fluid F from the supply tank 20 and measure the concentration of silicate included in the fluid F, and a storage tank 40 storing the fluid F discharged from the silicate concentration monitoring device 10. Because a tiny amount of silicate may be eluted from glass, each component of the silicate concentration monitoring device 1 may be preferably formed of a plastic material.

The supply tank 20 as a tank storing the fluid F in which a silicate concentration is to be measured may be configured to store the fluid F that is a liquid. In the specification, the fluid F means a solution including a chemical to be used in a semiconductor process. However, the fluid F does not mean only a chemical to be used in a semiconductor process and may include all kinds of solutions including silicate. In some embodiments, the fluid F may include an acidic solution, e.g., a sulfuric acid solution.

In the specification, silicate may have a meaning including both an ionic form (SiO₄⁴⁻) and a solid salt form. Silicate may have the ionic form or the solid salt form according to the pH concentration of a solution including the silicate. For example, when the solution including the silicate is acidic, the silicate may exist in the solid salt form, and when the solution including the silicate is neutral or basic, the silicate may exist in the ionic form. The silicate in the ionic form may be anionic and include, for example, SiO(OH)₃⁻ and SiO₄⁴⁻. SiO(OH)₃⁻ and SiO₄⁴⁻ are examples of silicate ions, and the silicate ions are not limited thereto and may include all forms of having silicon (Si) and oxygen (O) elements and being anionic.

The fluid F may be supplied to the silicate concentration monitoring device 10 by a fluid feed pump 50. The fluid feed pump 50 may be properly designed or selected by considering the properties, e.g., the phase, the boiling point, the viscosity, the specific gravity, and the like, of a fluid to be supplied.

As shown in FIG. 1A, the silicate concentration monitoring device 10 may include a concentrator 110 configured to increase the concentration of silicate in the fluid F, a solution reactor 130 configured to receive the fluid F from the concentrator 110 through a solution injector 120 and make the fluid F react with a reagent RG so as to develop molybdenum blue (blue color), a reagent storage 140 storing the reagent RG to be introduced to the solution reactor 130, and a concentration analyzer 150 configured to receive the fluid F from the solution reactor 130, measure the absorbance of the fluid F at a particular wavelength (e.g., 810 nm), and then output the concentration of silicate in the fluid F.

As shown in FIG. 1B, to monitor the concentration of silicate in the fluid F, operation S10 of passing the fluid F including the silicate through the concentrator 110 to increase the concentration of the silicate, operation S20 of passing the fluid F through the solution reactor 130 to introduce molybdic acid and a reducer to the fluid F, and operation S30 of passing the fluid F through the concentration analyzer 150 to output a quantified silicate concentration by emitting light on the fluid F and measuring the absorbance of the fluid F at a wavelength of 810 nm may be performed.

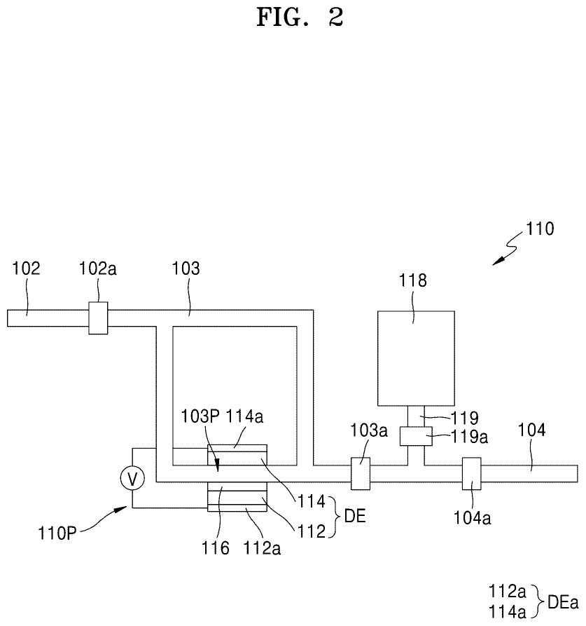

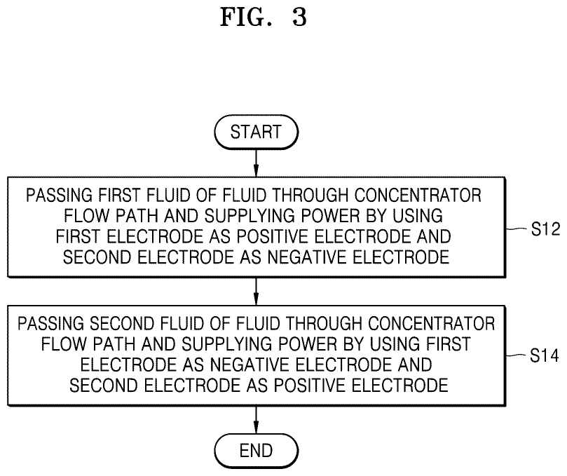

The concentrator 110 may include an electrode to which silicate ions in the fluid F may be adsorbed, to receive the fluid F from the supply tank 20 and increase the silicate concentration of the fluid F. A configuration of the concentrator 110 is described below in detail with reference to FIG. 2, and a method, performed by the concentrator 110, of increasing the concentration of silicate in the fluid F is described below in detail with reference to FIGS. 3, 4A, 4B, 5, and 6.

The concentrator 110 may receive the fluid F from the supply tank 20, wherein the concentrator 110 first receives a first fluid F1 that is a portion of the fluid F and then receives a second fluid F2 that is the remaining portion of the fluid F. Herein, an amount of the first fluid F1 that is introduced may be greater than an amount of the second fluid F2 that is introduced. Silicate in the first fluid F1 may be adsorbed to a positive electrode in the concentrator 110 in the form of silicate ions, and the first fluid F1 from which the concentration of silicate ions has been relatively reduced may be stored in a storage container in the concentrator 110. Thereafter, as the second fluid F2 is transferred to the concentrator 110, the silicate ions adsorbed to the positive electrode in the concentrator 110 may be detached therefrom and exist in the second fluid F2, and the second fluid F2 may flow toward the solution reactor 130 along a second flow path 104 in an open state of a second valve 104a. The solution injector 120 may be disposed on the second flow path 104. However, this is only illustrative, and in some embodiments, the solution injector 120 may be omitted.

The solution reactor 130 may include a space in which the reagent RG is received from the reagent storage 140 and the fluid F reacts with the reagent RG. The fluid F may be the second fluid F2 which is transferred from the concentrator 110, and of which the silicate concentration has increased. The silicate included in the fluid F may exist in the ionic form or the solid salt form according to the pH concentration of the fluid F. The reagent storage 140 may be configured to store the reagent RG to be introduced to the solution reactor 130 and introduce a certain amount of the reagent RG to the solution reactor 130.

In the specification, the reagent RG indicates a material for forming a silicomolybdic complex compound with silicate included in the fluid F such that molybdenum blue (blue color) is developed. The concentration of silicate included in the fluid F may be estimated by measuring the darkness of a color developed by the reagent RG.

In embodiments, the reagent RG may include a molybdic compound and a reducer. For example, the reagent RG may include not only molybdic acid (H₂MoO₄) but also ammonium molybdate ((NH₄)₆Mo₇O₂₄·4H₂O), lithium molybdate (Li₂MoO₄), or phosphomolybdic acid (H₃[PMo₁₂O₄₀]·nH₂O). For example, the reducer may include ascorbic acid (C₆H₈O₆).

In embodiments, the reagent RG may further include a pH control agent. The pH control agent may adjust the pH concentration of the fluid F to be about 5 to about 9 when the fluid F transferred to the solution reactor 130 is acidic (the term “about” means±5% for purposes of this specification). For example, the pH control agent may be a basic material and include sodium hydroxide.

According to the prior art, when a fluid is acidic, a pH range is relatively low, and thus, a graph of an absorbance with respect to a silicate concentration shows that there is no linear proportional relationship between the silicate concentration and the absorbance due to various causes, such as a stable silicomolybdic complex compound not being formed.

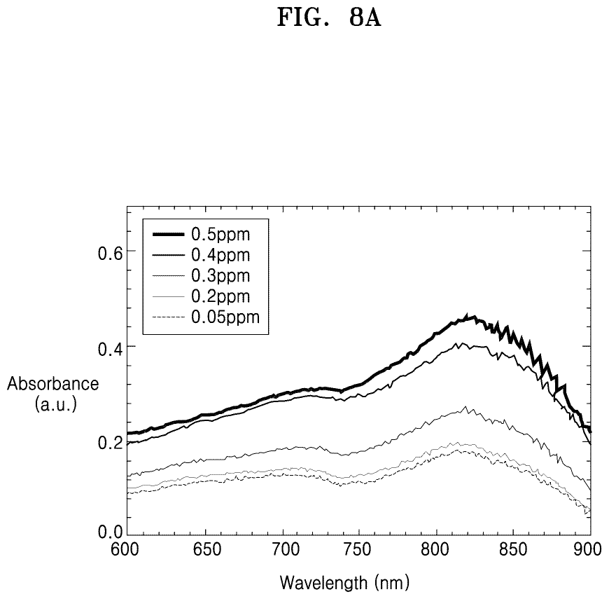

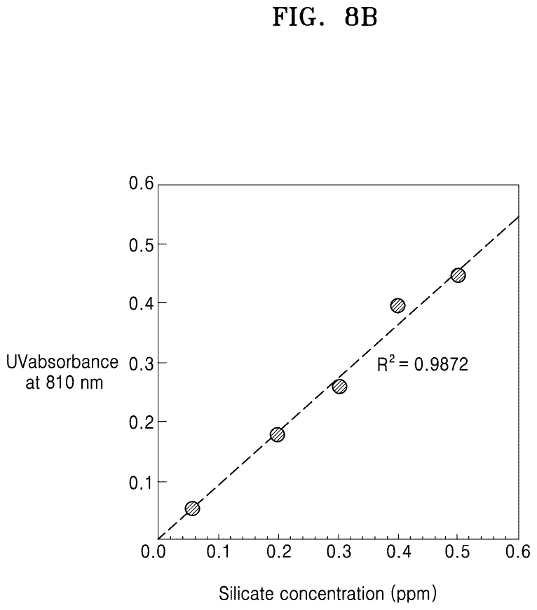

According to embodiments, even when the fluid F is acidic, the pH concentration of the fluid F may be adjusted to be about 5 to about 9 by using the pH control agent, and thus, a linear proportional relationship between a silicate concentration and an absorbance is established because a relatively stable silicomolybdic complex compound may be formed. The proportional relationship between a silicate concentration and an absorbance is particularly described below with reference to FIGS. 8A and 8B.

In embodiments, the molybdic compound may be introduced at a mass ratio of about 0.5% to about 5% with respect to the mass of the second fluid F2. The reducer may be introduced at a mass ratio of about 0.5% to about 5% with respect to the mass of the second fluid F2. The pH control agent may be introduced in an amount by which the pH concentration of the second fluid F2 is adjusted to be about 5 to about 9 or about 6 to about 8. The molybdic compound may be introduced and neglected for a certain time to induce a reaction. Thereafter, the reducer may be introduced and neglected for a certain time to induce a reduction reaction. The pH control agent may be introduced before the molybdic compound is introduced. Each of the molybdic compound and the reducer may be introduced in a liquid solution form.

The introduced molybdic compound may react with silicate, thereby forming a silicomolybdic complex compound, and the silicomolybdic complex compound may be reduced by ascorbic acid, thereby developing molybdenum blue (blue color).

When the second fluid F2 is transferred from the concentrator 110 to the solution reactor 130, a certain amount of the reagent RG may be introduced from the reagent storage 140 to the second fluid F2 in the solution reactor 130 along a third flow path 106 in an open state of a third valve 106a. Thereafter, a chemical reaction of forming a silicomolybdic complex compound and a reduction reaction of developing molybdenum blue (blue color) may occur in the solution reactor 130. The second fluid F2 in which the molybdenum blue (blue color) has been developed in the solution reactor 130 may flow toward the concentration analyzer 150 along a fourth flow path 108 in an open state of a fourth valve 108a.

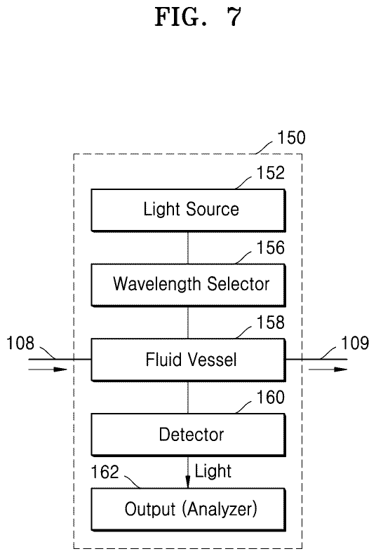

The concentration analyzer 150 may include a configuration capable of receiving the fluid F from the solution reactor 130, analyzing the absorbance of the fluid F, and estimating and calculating the concentration of silicate in the fluid F from the absorbance by using a graph about a relationship between a pre-measured silicate concentration and an absorbance at a particular wavelength (e.g., 810 nm). The configuration of the concentration analyzer 150 is described below in detail with reference to FIG. 7.

The concentration analyzer 150 may receive the fluid F from the solution reactor 130 and analyze the absorbance and silicate concentration of the fluid F. The fluid F analyzed by the concentration analyzer 150 may flow toward the storage tank 40 along a fifth flow path 109 in an open state of a fifth valve 109a.

The fluid F having passed through the silicate concentration monitoring device 10 is stored in the storage tank 40. Thereafter, the fluid F may be loaded on a transportation means from the storage tank 40 and then used in a process requiring the fluid F, but the present disclosure is not limited thereto.

Hereinafter, the configuration of the concentrator 110 is described in detail.

FIG. 2 illustrates the concentrator 110 according to embodiments.

Referring to FIG. 2, the concentrator 110 may include a circulation flow path 103, an ion adsorber 110P, and a storage container 118. The second flow path 104 may extend from the circulation flow path 103 to connect the circulation flow path 103 to the solution reactor 130 (see FIG. 1A), and the second valve 104a may be disposed on the second flow path 104. In other words, the second flow path 104 may extend from a concentrator flow path 103P that is a portion of the circulation flow path 103 and be connected to the solution reactor 130 (see FIG. 1A). A connection flow path 119 may branch from the second flow path 104 and connect the circulation flow path 103 to the storage container 118, and a connection valve 119a may be disposed on the connection flow path 119.

The circulation flow path 103 may be between a first flow path 102 and the second flow path 104, and unlike the first flow path 102 and the second flow path 104 in a one-way structure, the circulation flow path 103 may be configured in a closed loop shape in which a start point of the circulation flow path 103 is connected to an end point thereof such that the fluid F circulates inside the circulation flow path 103.

The ion adsorber 110P may include an electrode DE including a first electrode 112 and a second electrode 114 spaced apart from the first electrode 112, a current collector DEa disposed at one side of the electrode DE and configured to supply power to the electrode DE, the concentrator flow path 103P that is a passage through which the fluid F moves between the first electrode 112 and the second electrode 114, and a cation exchange membrane 116 disposed between the first electrode 112 and the concentrator flow path 103P. The concentrator flow path 103P may form a portion of the circulation flow path 103.

In embodiments, the electrode DE may include the first electrode 112 and the second electrode 114 spaced apart from the first electrode 112 with the concentrator flow path 103P and the cation exchange membrane 116 therebetween. For example, the first electrode 112 may include a porous carbon electrode, and the second electrode 114 may include graphite.

Because the second electrode 114 includes graphite, a hydrogen generation reaction may occur on the second electrode 114, thereby increasing the pH of the fluid F. In embodiments, anions output from the graphite included in the second electrode 114 may react with the fluid F flowing through the concentrator flow path 103P to generate hydroxyl ions (OH⁻), and the hydroxyl ions (OH⁻) generated from the second electrode 114 may increase pH in the fluid F.

When the fluid F is acidic, silicate may exist in a solid salt form in the fluid F, but according to embodiments, even when the fluid F introduced to the concentrator 110 is acidic and has low pH, hydroxyl ions (OH⁻) are generated from the second electrode 114, and thus, the pH of the fluid F may increase. Therefore, according to the increase in the pH of the fluid F, silicate may transit from the solid salt form to an ionic form and exist in the ionic form. When the fluid F introduced to the concentrator 110 is neutral or basic, silicate may exist in the fluid F in the ionic form.

The current collector DEa may include a first current collector 112a adjacent to the first electrode 112 and a second current collector 114a adjacent to the second electrode 114. The current collector DEa may supply power to the electrode DE.

In some embodiments, to adsorb silicate ions to the first electrode 112, the first electrode 112 may be a positive electrode by the first current collector 112a configured to supply power to the first electrode 112, and the second electrode 114 may be a negative electrode by the second current collector 114a configured to supply power to the second electrode 114. Anionic silicate ions may be adsorbed to the first electrode 112 that is a positive electrode. To further efficiently adsorb silicate ions to the first electrode 112, a porous membrane having a relatively wide surface area may be used for the first electrode 112. Cations may be adsorbed to the second electrode 114 that is a negative electrode.

Even when the fluid F introduced to the concentrator 110 is acidic, solid silicate is not ionic and thus cannot be adsorbed to the first electrode 112, but because hydroxyl ions (OH⁻) are generated from the second electrode 114, the pH of the fluid F may increase, and thus, the solid silicate existing in the fluid F may transit to silicate ions such that the silicate ions are adsorbed to the first electrode 112.

The cation exchange membrane 116 disposed between the first electrode 112 and the concentrator flow path 103P may perform filtering such that only silicate ions among ions to be adsorbed to the first electrode 112 pass through the cation exchange membrane 116. Through the use of the cation exchange membrane 116, the occurrence of a co-ion repulsion effect may be prevented. That is, a phenomenon that silicate ions are not adsorbed to the first electrode 112 due to an effect in which ions (cations) having charges opposite to those of the silicate ions approach the first electrode 112 and are repulsed by the first electrode 112 may be minimized, thereby improving the adsorption rate of silicate ions. In other words, the cation exchange membrane 116 may increase the efficiency of a forward reaction of adsorbing ions having negative charges to the first electrode 112 and simultaneously suppress the occurrence of a side reaction.

FIG. 3 is a flowchart illustrating a method of increasing the silicate concentration in the concentrator 110, according to embodiments.

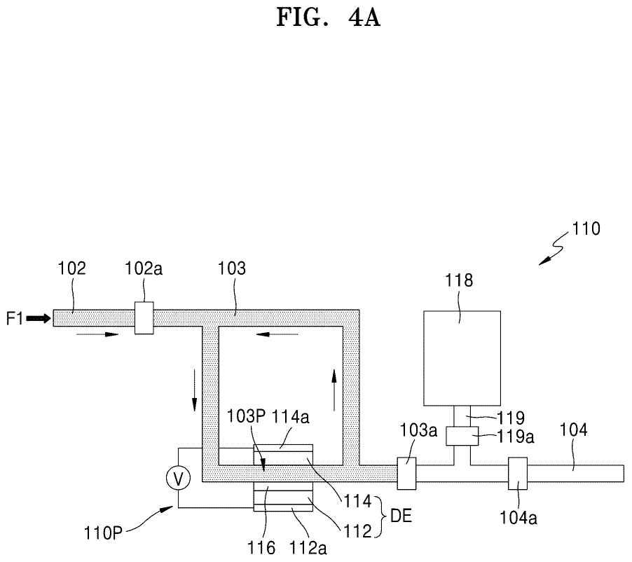

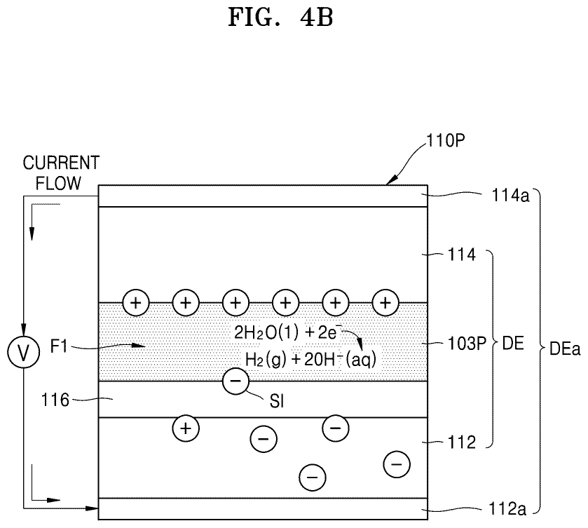

FIGS. 4A, 4B, 5, and 6 illustrate the method of increasing the silicate concentration the concentrator 110, according to embodiments. Particularly, FIG. 4B is an enlarged view illustrating a method of adsorbing silicate ions in the ion adsorber 110P of the concentrator 110 of FIG. 4A.

Hereinafter, the ion adsorber 110P and an operation method of the concentrator 110 including the ion adsorber 110P are described in detail with reference to FIGS. 3, 4A, 4B, 5, and 6.

As shown in FIG. 3, the concentrator 110 may perform operation S12 of passing the first fluid F1 of the fluid F through the concentrator flow path 103P and supplying power by using the first electrode 112 as a positive electrode and the second electrode 114 as a negative electrode and operation S14 of passing the second fluid F2 of the fluid F through the concentrator flow path 103P and supplying power by using the first electrode 112 as the negative electrode and the second electrode 114 as the positive electrode.

As shown in FIG. 4A, the concentrator 110 may receive the first fluid F1 from the supply tank 20 (see FIG. 1A) through the first flow path 102 in an open state of a first valve 102a. The first fluid F1 may circulate along the circulation flow path 103 a plurality of times, and because a portion of the circulation flow path 103 may form the concentrator flow path 103P of the ion adsorber 110P, the first fluid F1 may flow toward the concentrator flow path 103P of the ion adsorber 110P along the circulation flow path 103.

As shown in FIG. 4B, in the ion adsorber 110P, by the current collector DEa, the first electrode 112 of the electrode DE may operate as the positive electrode, and the second electrode 114 of the electrode DE may operate as the negative electrode. Anions may be generated from the second electrode 114 including graphite, and hydroxyl ions (OH) may be generated from the anions. The pH of the first fluid F1 may increase due to the hydroxyl ions (OH⁻), and accordingly, silicate inside the first fluid F1 may exist in an ionic form. Silicate ions SI are anionic and thus may be adsorbed to the first electrode 112 that is the positive electrode.

The first fluid F1 circulates along the circulation flow path 103 a plurality of times, and in a process in which the first fluid F1 circulates along the circulation flow path 103 the plurality of times, the silicate ions SI included in the first fluid F1 may be adsorbed to the first electrode 112, thereby relatively decreasing the concentration of the silicate ions SI in the first fluid F1. For example, the number of circulation times of the first fluid F1 along the circulation flow path 103 may be about 15 to about 30 but may be freely adjusted according to processes. In addition, the first fluid F1 may be introduced to the concentrator 110 several times instead of all at once. For example, even when 5,000 mL of the first fluid F1 is prepared, instead of introducing the 5,000 mL of the first fluid F1 to the concentrator 110 all at once, about 30 mL to about 40 mL of the first fluid F1 may be introduced to the concentrator 110 a plurality of times.

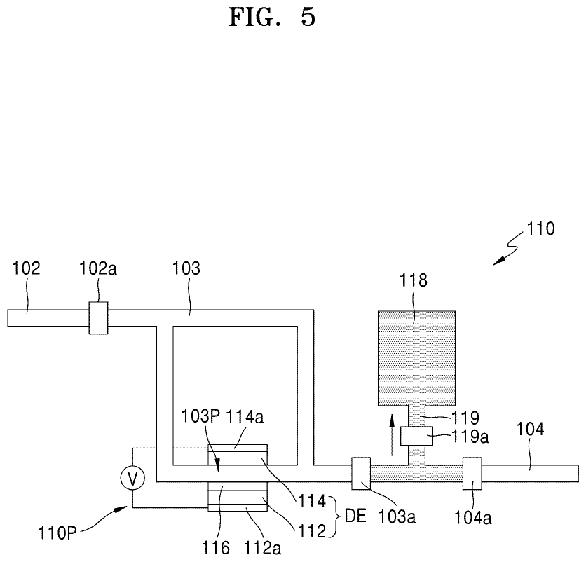

As shown in FIG. 5, the first fluid F1 of which the silicate concentration has decreased may flow along the second flow path 104 in an open state of a circulation flow path valve 103a, then flow toward the connection flow path 119 branching from the second flow path 104 in an open state of the connection valve 119a, and be stored in the storage container 118. In this case, the second valve 104a may be in a closed state. Because the first fluid F1 may be introduced to the concentrator 110 a plurality of times instead of all at once, the first fluid F1 may be stored in the storage container 118 the plurality of times instead of all at once.

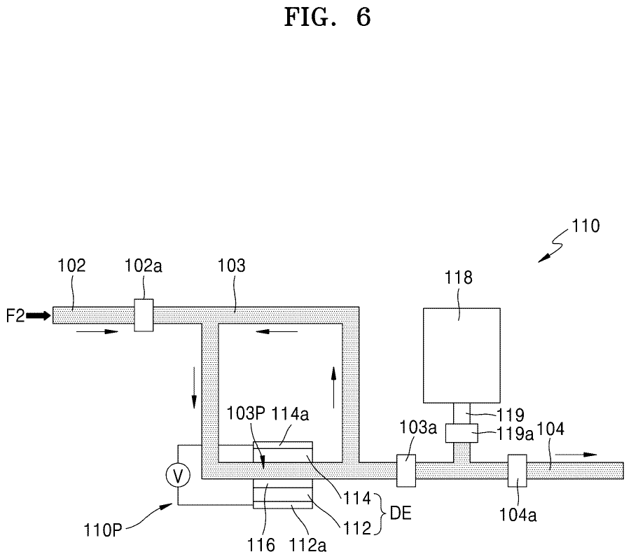

As shown in FIG. 6, after the first fluid F1 is stored in the storage container 118, the second fluid F2 may be introduced to the concentrator 110. In the open state of the first valve 102a, the second fluid F2 may be supplied from the supply tank 20 (see FIG. 1A) through the first flow path 102. An amount of the second fluid F2 that is introduced may be dramatically less than an amount of the first fluid F1 that is introduced. For example, the amount of the second fluid F2 that is introduced may be about 0.03% to about 0.05% of the amount of the first fluid F1 that is introduced. For example, the first fluid F1 may be about 4,000 mL to about 6,000 mL, and the second fluid F2 may be about 1 mL to about 3 mL.

The second fluid F2 may circulate along the circulation flow path 103 a single time, and in some embodiments, the second fluid F2 may circulate along the circulation flow path 103 a plurality of times but a relatively smaller number of times than the circulation number of times of the first fluid F1. The second fluid F2 may flow toward the concentrator flow path 103P of the ion adsorber 110P along the circulation flow path 103.

In the ion adsorber 110P, by the current collector DEa, the first electrode 112 of the electrode DE may operate as the negative electrode, and the second electrode 114 of the electrode DE may operate as the positive electrode. Unlike the direction (e.g., referred to as a first direction) of an electric field described with reference to FIGS. 4A and 4B, in FIG. 6, power may be applied such that an electric field is formed in the direction (e.g., referred to as a second direction) opposite to the direction of the electric field described with reference to FIGS. 4A and 4B. The first direction may be defined as the direction from the first electrode 112 to the second electrode 114, and the second direction may be defined as the direction from the second electrode 114 to the first electrode 112. Therefore, as the first electrode 112 operates as the negative electrode, silicate ions may be detached from the first electrode 112.

When the second fluid F2 is acidic, the silicate ions may transit to a solid salt form and exist in the second fluid F2, and when the second fluid F2 is neutral or basic, the silicate ions may maintain the ionic form and exist in the second fluid F2.

The amount of the second fluid F2 is dramatically less than the amount of the first fluid F1, and thus, the concentration of silicate in the second fluid F2 may be dramatically higher than the concentration of silicate in the first fluid F1. For example, the concentration of silicate included in the second fluid F2 may be about 10 times to about 20 times higher than the concentration of silicate included in the first fluid F1.

In an experimental example, 5,000 mL of a solution including 480 ppb of silicate is introduced as the first fluid F1, and 2 mL of a solution including 480 ppb of silicate is introduced as the second fluid F2. When the first fluid F1 is introduced, 12 V power is applied to the electrode DE by the current collector DEa, and a rate of introducing the first fluid F1 is about 6 mL/min. When the second fluid F2 is introduced, −24 mA power is applied to the electrode DE by the current collector DEa, and a rate of introducing the second fluid F2 is about 0.5 mL/min. It is identified that the second fluid F2 having passed through the concentrator 110 is discharged as 2 mL of a solution including 5,330 ppb of silicate, which has increased in a silicate concentration by about 11.1 times.

The second fluid F2 of which the silicate concentration has increased may flow along the second flow path 104 in the open state of the circulation flow path valve 103a and then flow along the second flow path 104 in the open state of the second valve 104a. In this case, the connection valve 119a may be in a closed state. The second fluid F2 having flowed along the second flow path 104 may be transferred to the solution reactor 130.

Hereinafter, the concentration analyzer 150 is described in detail.

FIG. 7 schematically illustrates the concentration analyzer 150 according to embodiments.

Referring to FIG. 7, the concentration analyzer 150 may include a light source 152 configured to emit light on the second fluid F2, a wavelength selector 156 configured to separate only light of a particular wavelength from the light emitted from the light source 152, a concentration analyzer fluid vessel 158 that is a passage through which the second fluid F2 moves, a detector 160 configured to measure the intensity of light and convert the intensity of the light into an electrical signal, and an analyzer 162 configured to convert the electrical signal transmitted from the detector 160 into a quantified silicate concentration.

In embodiments, the wavelength selector 156 may separate only light of a wavelength, for example, in a range of about 800 nm to about 820 nm or of 810 nm from the light emitted from the light source 152. A molybdic blue complex has a maximum absorbance in the range of about 800 nm to about 820 nm, and thus, the wavelength selector 156 may separate light of a wavelength in the range of about 800 nm to about 820 nm or of 810 nm.

The analyzer 162 may output an absorbance in the light of the particular wavelength separated by the wavelength selector 156 by using the electrical signal transmitted from the detector 160, and in this case, the concentration of silicate included in the second fluid F2 (see FIG. 1A) may be derived by substituting the output absorbance into a relational expression between the absorbance at the particular wavelength and a silicate concentration obtained from a graph about a relationship among a pre-measured silicate concentration, a wavelength, and an absorbance. After deriving the concentration of the silicate included in the second fluid F2 (see FIG. 1A), the concentration of silicate included in the first fluid F1 (see FIG. 1A) may be estimated by substituting the concentration of the silicate included in the second fluid F2 (see FIG. 1A) into a concentration ratio in the concentrator 110 (see FIG. 1A).

For example, the concentration analyzer 150 may measure an absorbance at the wavelength of 810 nm and derive the concentration of the silicate included in the second fluid F2 (see FIG. 1A) by substituting the measured absorbance into a relational expression obtained from a graph between a pre-measured silicate concentration and an absorbance at the wavelength of 810 nm. After deriving the concentration of the silicate included in the second fluid F2 (see FIG. 1A), the concentration of the silicate included in the first fluid F1 (see FIG. 1A) may be estimated by substituting the concentration of the silicate included in the second fluid F2 (see FIG. 1A) into the concentration ratio in the concentrator 110 (see FIG. 1A). For example, the concentration of the silicate included in the first fluid F1 (see FIG. 1A) may be estimated by multiplying the concentration of the silicate included in the second fluid F2 (see FIG. 1A) by a value of about 0.1 to about 0.05.

According to a silicate concentration monitoring device and a silicate concentration monitoring method according to embodiments, the concentration of silicate may be estimated even for silicate included with a concentration of about 0.001 ppm to about 1 ppm, and the concentration of silicate may be quantified and monitored even when the silicate remains with a relatively dilute concentration, and thus, silicate remaining in a semiconductor chemical material may be minimized, thereby reducing product defects due to the remaining silicate.

In addition, the concentration of silicate may be estimated even for silicate included in an acidic solution, and thus, the present disclosure may contribute to minimization of silicate remaining in a semiconductor chemical material as well, thereby reducing product defects due to the remaining silicate.

FIG. 8A is an ultraviolet (UV) absorbance graph according to a silicate concentration and a wavelength by a silicate concentration monitoring device according to embodiments.

FIG. 8B is a UV absorbance graph at the wavelength of 810 nm according to a silicate concentration by a silicate concentration monitoring device according to embodiments.

FIGS. 8A and 8B relate to an experiment of preparing solutions in which 50 μL of a molybdic compound, 20 μL of ascorbic acid, and 1.4 mL of sodium hydroxide of a concentration of 5 M are mixed and reacted with each of 2 mL of 9.8% sulfuric acid solutions in which 0.05 ppm, 0.2 ppm, 0.3 ppm, 0.4 ppm, and 0.5 ppm of silicate are respectively included, and measuring an absorbance of each solution under light of the wavelength of 810 nm.

FIG. 8A is a graph about a relationship among a silicate concentration, a wavelength, and an absorbance, and FIG. 8B is a graph about a relationship between the silicate concentration measured with reference to FIG. 8A and an absorbance at the wavelength of 810 nm.

As shown in FIG. 8B, as the silicate concentration increases, the absorbance in the wavelength of 810 nm may proportionally increase, and the silicate concentration may be linearly proportional to the absorbance at the wavelength of 810 nm. In the graph with a silicate concentration as the X axis and an absorbance at the wavelength of 810 nm as the Y axis, a gradient is about 0.9872. Therefore, an equation about a relationship between a silicate concentration and an absorbance at the wavelength of 810 nm is as follows.

$$y = 0.9872 x \qquad [ Equation 1 ]$$

In Equation 1, y denotes an absorbance at the wavelength of 810 nm, and x denotes a silicate concentration (ppb).

As shown in FIGS. 8A and 8B, a graph and an equation about a relationship between a silicate concentration and an absorbance at the wavelength of 810 nm may be derived. Through the derived graph and equation, the concentration of silicate may be measured by measuring an absorbance at the wavelength of 810 nm in an actual process. Particularly, the concentration of silicate included in a second fluid may be estimated by measuring an absorbance at the wavelength of 810 nm and using the graph and equation, and the concentration of silicate included in a first fluid may be estimated by substituting the concentration of the silicate included in the second fluid into a concentration ratio in a concentrator.

While the present disclosure has been particularly shown and described with reference to embodiments thereof, it will be understood that various changes in form and details may be made therein without departing from the spirit and scope of the following claims.

What is claimed is:

1. A device for monitoring a concentration of silicate in a fluid including the silicate, the device comprising:
a concentrator;
a solution reactor configured to introduce a molybdic compound and a reducer to the fluid transferred from the concentrator; and
a concentration analyzer configured to output a quantified silicate concentration by measuring, at a wavelength of about 800 nm to about 820 nm, an absorbance of the fluid transferred from the solution reactor,
wherein the concentrator comprises:
a first electrode;
a second electrode spaced apart from the first electrode;
a current collector configured to supply power to the first electrode and the second electrode at one side of each of the first electrode and the second electrode;
a concentrator flow path which is disposed between the first electrode and the second electrode and is a passage through which the fluid moves; and
a cation exchange membrane disposed between the first electrode and the concentrator flow path.

2. The device of claim 1, wherein the fluid is acidic.

3. The device of claim 1, wherein, in the concentrator, the first electrode is a positive electrode, and the second electrode is a negative electrode.

4. The device of claim 1, wherein the concentrator increases the concentration of the silicate included in the fluid by about 10 times to about 20 times.

5. The device of claim 1, wherein, in the concentrator, the first electrode comprises a porous carbon electrode, and the second electrode comprises graphite.

6. The device of claim 1, wherein, in the concentrator, the second electrode generates hydroxyl ions from the fluid to maintain a pH concentration of the fluid at about 5 to about 9.

7. The device of claim 1, wherein, in the concentrator, only the silicate passes from the fluid to the first electrode through the cation exchange membrane.

8. The device of claim 1, wherein the molybdic compound includes molybdic acid (H₂MoO₄), ammonium molybdate ((NH₄)₆Mo₇O₂₄·4H₂O), lithium molybdate (Li₂MoO₄), or phosphomolybdic acid (H₃[PMo₁₂O₄₀]·nH₂O).

9. The device of claim 1, wherein the reducer includes ascorbic acid (C₆H₈O₆).

10. The device of claim 1, wherein a basic pH control agent is further introduced to the solution reactor.

11. The device of claim 1, wherein the concentration analyzer comprises:
a light source configured to emit light on the fluid;
a wavelength selector configured to separate a particular wavelength from a wavelength of the light;
a concentration analyzer fluid vessel that is a passage through which the fluid moves;
a detector configured to measure intensity of the light having passed through the fluid and convert the intensity of the light into an electrical signal; and
an analyzer configured to convert the electrical signal transmitted from the detector into a quantified silicate concentration.

12. A device for monitoring a concentration of silicate in an acidic fluid including the silicate, the device comprising:
a concentrator;
a solution reactor configured to introduce a molybdic compound, a basic pH control agent, and a reducer to the fluid transferred from the concentrator; and
a concentration analyzer configured to output a quantified silicate concentration by measuring, at a wavelength of about 800 nm to about 820 nm, an absorbance of the fluid transferred from the solution reactor,
wherein the concentrator comprises:
a first electrode including a porous carbon electrode;
a second electrode spaced apart from the first electrode and including graphite;
a current collector configured to supply power to the first electrode and the second electrode at one side of each of the first electrode and the second electrode;
a concentrator flow path which is disposed between the first electrode and the second electrode and is a passage through which the fluid moves; and
a cation exchange membrane disposed between the first electrode and the concentrator flow path,
the molybdic compound is introduced in an amount of about 0.5% to about 5% of an amount of the fluid introduced to the solution reactor,
the reducer is introduced in an amount of about 0.5% to about 5% of the amount of the fluid introduced to the solution reactor, and
the basic pH control agent is introduced in an amount by which a pH concentration of the fluid introduced to the solution reactor is adjusted to be about 5 to about 9.

13. The device of claim 12, wherein
the reducer includes ascorbic acid (C₆H₈O₆), and
the basic pH control agent includes sodium hydroxide.

14. The device of claim 12, wherein the concentration analyzer comprises:
a light source configured to emit light on the fluid;
a wavelength selector configured to separate a particular wavelength from a wavelength of the light;
a concentration analyzer fluid vessel that is a passage through which the fluid moves;
a detector configured to measure intensity of the light having passed through the fluid and convert the intensity of the light into an electrical signal; and
an analyzer configured to convert the electrical signal transmitted from the detector into a quantified silicate concentration.

15. A device for monitoring a concentration of silicate in a fluid including the silicate, the device comprising:
a concentrator;
a solution reactor configured to introduce a molybdic compound and a reducer to the fluid transferred from the concentrator; and
a concentration analyzer configured to output a quantified silicate concentration by measuring, at a wavelength of about 800 nm to about 820 nm, an absorbance of the fluid transferred from the solution reactor,
wherein the concentrator comprises:
a first electrode;
a second electrode spaced apart from the first electrode;
a current collector configured to supply power to the first electrode and the second electrode at one side of each of the first electrode and the second electrode;
a concentrator flow path which is disposed between the first electrode and the second electrode and is a passage through which the fluid moves; and
a cation exchange membrane disposed between the first electrode and the concentrator flow path,
wherein the molybdic compound includes molybdic acid (H₂MoO₄), ammonium molybdate ((NH₄)₆Mo₇O₂₄·4H₂O), lithium molybdate (Li₂MoO₄), or phosphomolybdic acid (H₃[PMo₁₂O₄₀]·nH₂O), and
wherein the reducer includes ascorbic acid (C₆H₈O₆).

16. The device of claim 15, wherein, in the concentrator, the first electrode is a positive electrode, and the second electrode is a negative electrode.

17. The device of claim 15, wherein, in the concentrator, the first electrode comprises a porous carbon electrode, and the second electrode comprises graphite.

18. The device of claim 15, wherein, in the concentrator, only the silicate passes from the fluid to the first electrode through the cation exchange membrane.

19. The device of claim 15, wherein the concentration analyzer comprises:
a light source configured to emit light on the fluid;
a wavelength selector configured to separate a particular wavelength from a wavelength of the light;
a concentration analyzer fluid vessel that is a passage through which the fluid moves;
a detector configured to measure intensity of the light having passed through the fluid and convert the intensity of the light into an electrical signal; and
an analyzer configured to convert the electrical signal transmitted from the detector into a quantified silicate concentration.

20. The device of claim 15, wherein the concentrator flow path is a portion of a circulation flow path which is configured in a closed loop shape.
